(19) United States
(12) Patent Application Publication
(10) Pub. No.: US 2022/0413261 A1
(43) Pub. Date: Dec. 29, 2022

(54) Optical Imaging Lens Assembly

(71) Applicant: ZHEJIANG SUNNY OPTICS CO., LTD., Ningbo (CN)

(72) Inventors: Dan HE, Ningbo (CN); Zheng FANG, Ningbo (CN); Saifeng LV, Ningbo (CN); Fujian DAI, Ningbo (CN); Liefeng ZHAO, Ningbo (CN)

(21) Appl. No.: 17/826,213

(22) Filed: May 27, 2022

(30) Foreign Application Priority Data
Jun. 28, 2021 (CN) 202110733100.5

(51) Int. Cl. G02B 9/06; G02B 13/00

(52) U.S. Cl. CPC G02B 9/06; G02B 13/003

(57) ABSTRACT

The disclosure provides an optical imaging lens assembly, which sequentially includes from an object side to an image side along an optical axis: a first lens group having a positive refractive power and including a first lens; and a second lens group having a positive refractive power and sequentially including from the first lens to the image side along the optical axis: a second lens, a third lens, a fourth lens, a fifth lens, a sixth lens, a seventh lens and an eighth lens, wherein the second lens has a positive refractive power; an object-side surface of the sixth lens is a convex surface, and an image-side surface of the sixth lens is a concave surface; the seventh lens has a positive refractive power; the eighth lens has a negative refractive power.

### CROSS-REFERENCE TO RELATED APPLICATION

The disclosure claims priority to and the benefit of Chinese Patent Application No. 202110733100.5, filed to the China National Intellectual Property Administration (CHIPA) on 28 Jun. 2021, which is hereby incorporated by reference in its entirety.

### TECHNICAL FIELD

The disclosure relates to the technical field of the optical elements, in particular to an optical imaging lens assembly.

### BACKGROUND

As the portable electronic products, such as smart phones develop rapidly, the photosensitive chip carried in a photographing module of the portable electronic product is also being updated. Correspondingly, the optical imaging lens assembly in the photographing module is required to upgrade imaging capability and structure to match the requirements of the photosensitive chip. In the future technical field of the optical imaging lens assembly, for satisfying market demands, an optical imaging lens assembly with high pixel, high imaging quality and small size will become a main development trend in the field of optical imaging lens assemblies.

### SUMMARY

In an embodiment, the disclosure provides an optical imaging lens assembly, which sequentially includes from an object side to an image side along an optical axis: a first lens group having a positive refractive power and including a first lens; and a second lens group having a positive refractive power and sequentially including from the first lens to the image side along the optical axis: a second lens, a third lens, a fourth lens, a fifth lens, a sixth lens, a seventh lens and an eighth lens, wherein the second lens has a positive refractive power; an object-side surface of the sixth lens is a convex surface, and an image-side surface of the sixth lens is a concave surface; the seventh lens has a positive refractive power; the eighth lens has a negative refractive power; ImgH is a half of a diagonal length of an effective pixel region of an photosensitive element on an imaging surface of the optical imaging lens assembly, TTL is a distance from an object-side surface of the first lens to the imaging surface on the optical axis, and ImgH and TTL satisfy: 5 mm<ImgH×ImgH/TTL<10 mm; and at least one mirror surface from the object-side surface of the first lens to an image-side surface of the eighth lens is an aspheric surface.

In an implementation mode, an effective focal length FG2 of the second lens group and an effective focal length FG1 of the first lens group may satisfy: 2.7<FG2/FG1<4.2.

In an implementation mode, ImgH and TTL may satisfy: TTL/ImgH<1.3.

In an implementation mode, FOV is a maximum field of view of the optical imaging lens assembly, and FOV and a total effective focal length f of the optical imaging lens assembly may satisfy: 6.0 mm<f×tan(FOV/2)<7.0 mm.

In an implementation mode, an effective focal length f1 of the first lens, a curvature radius R1 of an object-side surface of the first lens and a curvature radius R2 of an image-side surface of the first lens may satisfy: 1.0f1/(R1+R2)<1.5.

In an implementation mode, an effective focal length f3 of the third lens, an effective focal length f5 of the fifth lens and an effective focal length f6 of the sixth lens may satisfy: 0/f3/(f5+f6)<1.5.

In an implementation mode, a curvature radius R5 of an object-side surface of the third lens, a curvature radius R6 of an image-side surface of the third lens, a curvature radius R3 of an object-side surface of the second lens and a curvature radius R4 of an image-side surface of the second lens may satisfy: 1.0<(R5+R6)/(R3+R4)<1.5.

In an implementation mode, an effective focal length f7 of the seventh lens, an effective focal length f8 of the eighth lens, a curvature radius R13 of an object-side surface of the seventh lens and a curvature radius R16 of an image-side surface of the eighth lens may satisfy: 1.2<(f7−f8)/(R13+R16)<1.8.

In an implementation mode, a center thickness CT7 of the seventh lens on the optical axis, a center thickness CT8 of the eighth lens on the optical axis and a spacing distance T78 between the seventh lens and the eighth lens on the optical axis may satisfy: 1.2<(CT7+CT8)/T78<1.8.

In an implementation mode, f34 is a combined focal length of the third lens and the fourth lens, f567 is a combined focal length of the fifth lens, the sixth lens and the seventh lens, and f34 and f567 may satisfy: 4.1<f34/f567<7.6.

In an implementation mode, SAG61 is a distance from an intersection point of the object-side surface of the sixth lens and the optical axis to an effective radius vertex of the object-side surface of the sixth lens on the optical axis, SAG62 is a distance from an intersection point of the image-side surface of the sixth lens and the optical axis to an effective radius vertex of the image-side surface of the sixth lens on the optical axis, SAG51 is a distance from an intersection point of an object-side surface of the fifth lens and the optical axis to an effective radius vertex of the object-side surface of the fifth lens on the optical axis, SAG52 is a distance from an intersection point of an image-side surface of the fifth lens and the optical axis to an effective radius vertex of the image-side surface of the fifth lens on the optical axis, and SAG61, SAG62, SAG51 and SAG52 may satisfy: 0.7<(SAG61+SAG62)/(SAG51+SAG52)<1.6.

In an implementation mode, a center thickness CT4 of the fourth lens on the optical axis, a spacing distance T45 between the fourth lens and the fifth lens on the optical axis and an edge thickness ET4 of the fourth lens may satisfy: 1.0<CT4/(T45+ET4)<1.6.

In an implementation mode, an edge thickness ET8 of the eighth lens, an edge thickness ET5 of the fifth lens, an edge thickness ET6 of the sixth lens and an edge thickness ET7 of the seventh lens may satisfy: 0.8<ET8/(ET5+ET6+ET7)<1.5.

In an implementation mode, the first lens may be made of glass.

In an implementation mode, an Abbe number of the first lens may satisfy: 58<V1<70.

In an implementation mode, the object-side surface of the first lens and an image-side surface of the first lens may be aspheric surfaces.

In another embodiment, the disclosure further provides an optical imaging lens assembly, which sequentially includes from an object side to an image side along an optical axis: a first lens group having a positive refractive power and including a first lens; and a second lens group having a positive refractive power and sequentially including from the first lens to the image side along the optical axis: a second lens, a third lens, a fourth lens, a fifth lens, a sixth lens, a seventh lens and an eighth lens, wherein the second lens has a positive refractive power; an object-side surface of the sixth lens is a convex surface, and an image-side surface of the sixth lens is a concave surface; the seventh lens has a positive refractive power; the eighth lens has a negative refractive power; ImgH is a half of a diagonal length of an effective pixel region of an photosensitive element on an imaging surface of the optical imaging lens assembly, TTL is a distance from an object-side surface of the first lens to the imaging surface on the optical axis, and ImgH and TTL satisfy: TTL/ImgH<1.3; and at least one mirror surface from the object-side surface of the first lens to an image-side surface of the eighth lens is an aspheric surface.

In an implementation mode, an effective focal length FG2 of the second lens group and an effective focal length FG1 of the first lens group may satisfy: 2.7<FG2/FG1<4.2.

In an implementation mode, FOV is a maximum field of view of the optical imaging lens assembly, FOV and a total effective focal length f of the optical imaging lens assembly may satisfy: 6.0 mm<f×tan(FOV/2)<7.0 mm.

In an implementation mode, an effective focal length f1 of the first lens, a curvature radius R1 of an object-side surface of the first lens and a curvature radius R2 of an image-side surface of the first lens may satisfy: 1.0<f1/(R1+R2)<1.5.

In an implementation mode, an effective focal length f3 of the third lens, an effective focal length f5 of the fifth lens and an effective focal length f6 of the sixth lens may satisfy: 0≤f3/(f5+f6)<1.5.

In an implementation mode, a curvature radius R5 of an object-side surface of the third lens, a curvature radius R6 of an image-side surface of the third lens, a curvature radius R3 of an object-side surface of the second lens and a curvature radius R4 of an image-side surface of the second lens may satisfy: 1.0<(R5+R6)/(R3+R4)<1.5.

In an implementation mode, an effective focal length f7 of the seventh lens, an effective focal length f8 of the eighth lens, a curvature radius R13 of an object-side surface of the seventh lens and a curvature radius R16 of an image-side surface of the eighth lens may satisfy: 1.2<(f7−f8)/(R13+R16)<1.8.

In an implementation mode, a center thickness CT7 of the seventh lens on the optical axis, a center thickness CT8 of the eighth lens on the optical axis and a spacing distance T78 between the seventh lens and the eighth lens on the optical axis may satisfy: 1.2<(CT7+CT8)/T78<1.8.

In an implementation mode, f34 is a combined focal length of the third lens and the fourth lens, f567 is a combined focal length of the fifth lens, the sixth lens and the seventh lens, and f34 and f567 may satisfy: 4.1<f34/f567<7.6.

In an implementation mode, SAG61 is a distance from an intersection point of the object-side surface of the sixth lens and the optical axis to an effective radius vertex of the object-side surface of the sixth lens on the optical axis, SAG62 is a distance from an intersection point of the image-side surface of the sixth lens and the optical axis to an effective radius vertex of the image-side surface of the sixth lens on the optical axis, SAG51 is a distance from an intersection point of an object-side surface of the fifth lens and the optical axis to an effective radius vertex of the object-side surface of the fifth lens on the optical axis, SAG52 is a distance from an intersection point of an image-side surface of the fifth lens and the optical axis to an effective radius vertex of the image-side surface of the fifth lens on the optical axis, and SAG61, SAG62, SAG51 and SAG52 may satisfy: 0.7<(SAG61+SAG62)/(SAG51+SAG52)<1.6.

In an implementation mode, a center thickness CT4 of the fourth lens on the optical axis, a spacing distance T45 between the fourth lens and the fifth lens on the optical axis and an edge thickness ET4 of the fourth lens may satisfy: 1.0<CT4/(T45+ET4)<1.6.

In an implementation mode, an edge thickness ET8 of the eighth lens, an edge thickness ET5 of the fifth lens, an edge thickness ET6 of the sixth lens and an edge thickness ET7 of the seventh lens may satisfy: 0.8<ET8/(ET5+ET6+ET7)<1.5.

In an implementation mode, the first lens may be made of glass.

In an implementation mode, an Abbe number of the first lens may satisfy: 58<V1<70.

In an implementation mode, the object-side surface of the first lens and an image-side surface of the first lens may be aspheric surfaces.

The disclosure adopts an optical imaging lens structure with eight lenses, a refractive power and a surface type of each lens, a center thickness of each lens, an on-axis spacing distance between each lens, etc. are reasonably distributed, and accordingly, the optical imaging lens assembly has at least one beneficial effect of high pixel, high imaging quality, compact structure, miniaturization, etc.

### BRIEF DESCRIPTION OF THE DRAWINGS

Other features, objectives, and advantages of the disclosure will become more apparent by means of the detailed description on following non-limiting embodiments, in conjunction with the accompanying drawings. In the drawings:

FIG. 1 shows a structural schematic diagram of an optical imaging lens assembly according to Embodiment 1 of the disclosure;

FIGS. 2A-2B show an astigmatism curve and a distortion curve of the optical imaging lens assembly of Embodiment 1 respectively;

FIG. 3 shows a structural schematic diagram of an optical imaging lens assembly according to Embodiment 2 of the disclosure;

FIGS. 4A-4B show an astigmatism curve and a distortion curve of the optical imaging lens assembly of Embodiment 2 respectively;

FIG. 5 shows a structural schematic diagram of an optical imaging lens assembly according to Embodiment 3 of the disclosure;

FIGS. 6A-6B show an astigmatism curve and a distortion curve of the optical imaging lens assembly of Embodiment 3 respectively;

FIG. 7 shows a structural schematic diagram of an optical imaging lens assembly according to Embodiment 4 of the disclosure;

FIGS. 8A-8B show an astigmatism curve and a distortion curve of the optical imaging lens assembly of Embodiment 4 respectively;

FIG. 9 shows a structural schematic diagram of an optical imaging lens assembly according to Embodiment 5 of the disclosure; and

FIGS. 10A-10B show an astigmatism curve and a distortion curve of the optical imaging lens assembly of Embodiment 5 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the illustrative implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this specification, the expressions of first, second, third, etc. are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. Specifically, aspheric or aspheric shape, shown in the accompanying drawings, is showed by way of example. That is, the spherical shape or the aspherical shape is not limited to the spherical shape or the aspherical shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if the lens surface is a concave surface and a position of the concave surface is not defined, it indicates that the lens surface is a concave surface at least in the paraxial region. A surface of each lens closest to an object-side is called an object-side surface of the lens, and a surface of each lens closest to an imaging surface is called an image-side surface of the lens.

It also should be understood that terms “include”, “including”, “have”, “contain” and/or “containing”, used in this description, represent existence of a stated feature, component and/or part but do not exclude existence or addition of one or more other features, components and parts and/or combinations thereof. In addition, expressions like “at least one in . . .” may appear after a list of listed features not to modify an individual component in the list but to modify the listed features. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by the general technical personnel in the field of the disclosure. It also should be understood that the terms (for example, terms defined in a common dictionary) should be explained to have meanings consistent with the meanings in the context of correlation technique and cannot be explained with ideal or excessively formal meanings, unless clearly defined like this in the disclosure.

It should be noted that the embodiments in the disclosure and features in the embodiments can be combined without conflicts. The disclosure will be described below with reference to the drawings and in combination with the embodiments in detail.

The features, principles and other aspects of the disclosure will be described below in detail.

The optical imaging lens assembly according to the exemplary embodiment of the disclosure includes a first lens group and a second lens group. The first lens group and the second lens group may be sequentially arranged from an object side to an image side along an optical axis.

In an exemplary embodiment, the first lens group has a positive refractive power and may include, for example, one lens having a refractive power, that is, a first lens. Exemplarily, the first lens may have a positive refractive power. When the first lens group includes a plurality of lenses, the first lens is a lens closest to the object side. The first lens group may be independently assembled by using a tilt calibration apparatus under the condition that a calibration effect satisfies a preset performance requirement, such that the first lens group may independently correct an imaging quality problem caused by tilt.

In an exemplary embodiment, the second lens group has a positive refractive power and may include, for example, seven lenses having refractive powers, that is, a second lens, a third lens, a fourth lens, a fifth lens, a sixth lens, a seventh lens and an eighth lens. The seven lenses are sequentially arranged from the first lens to the image side along the optical axis. There may be an air spacing between any two adjacent lenses from the second lens to the eighth lens.

In an exemplary embodiment, the second lens may have a positive refractive power; the third lens may have a positive refractive power or a negative refractive power; the fourth lens may have a positive refractive or a negative refractive power; the fifth lens may have a positive refractive or a negative refractive power; the sixth lens may have a positive refractive power or a negative refractive power, and an object-side surface thereof may be a convex surface, and an image-side surface thereof may be a concave surface; the seventh lens may have a positive refractive power; and the eighth lens may have a negative refractive power. By reasonably distributing the positive and negative refractive powers of each lens, a low-order aberration of the optical imaging lens assembly may be effectively balanced.

In an exemplary embodiment, the optical imaging lens assembly described above may further include at least one diaphragm. The diaphragm may be arranged at an appropriate position as desired, for example, arranged between the object side and the first lens.

In an exemplary embodiment, the optical imaging lens assembly may satisfy 5 mm<ImgH×ImgH/TTL<10 mm, wherein ImgH is a half of a diagonal length of an effective pixel region of an photosensitive element on an imaging surface of the optical imaging lens assembly, and TTL is a distance from an object-side surface of the first lens to the imaging surface of the optical imaging lens assembly on the optical axis. The optical imaging lens assembly satisfies: 5 mm<ImgH×ImgH/TTL<10 mm, so as to achieve features of ultra-thinness and high pixel of the optical imaging lens assembly. More specifically, ImgH and TTL may further satisfy: 5 mm<ImgH×ImgH/TTL<7 mm.

In an exemplary embodiment, the optical imaging lens assembly may satisfy 2.7<FG2/FG1<4.2, wherein FG2 is an effective focal length of the second lens group and FG1 is an effective focal length of the first lens group. The optical imaging lens assembly satisfies: 2.7<FG2/FG1<4.2, so as to improve an imaging quality, further to reduce the refractive power of the first lens, and to reduce an error sensitivity of product manufacturing.

In an exemplary embodiment, the optical imaging lens assembly may satisfy TTL/ImgH<1.3, wherein TTL is a distance from an object-side surface of the first lens to the imaging surface of the optical imaging lens assembly on the optical axis, and ImgH is a half of a diagonal length of an effective pixel region of a photosensitive element on the imaging surface of the optical imaging lens assembly. The optical imaging lens assembly satisfies: TTL/ImgH<1.3, such that the optical imaging structure is compact, a requirement for miniaturization is satisfied, and the optical imaging lens assembly further has functional features of high pixel and large aperture.

In an exemplary embodiment, the optical imaging lens assembly may satisfy 6.0 mm<f×tan(FOV/2)<7.0 mm, wherein f is a total effective focal length of the optical imaging lens assembly, and FOV is a maximum field of view of the optical imaging lens assembly. The optical imaging lens assembly satisfies: 6.0 mm<f×tan(FOV/2)<7.0 mm, such that the optical imaging lens assembly has an imaging effect of large image surface.

In an exemplary embodiment, the optical imaging lens assembly may satisfy 1.0<f1/(R1+R2)<1.5, wherein f1 is an effective focal length of the first lens, R1 is a curvature radius of an object-side surface of the first lens, and R2 is a curvature radius of an image-side surface of the first lens. The optical imaging lens assembly satisfies: 1.0<f1(R1+R2)<1.5, so as to control a deflection angle of an edge field of view at the first lens, and to effectively reduce a sensitivity of the optical imaging lens assembly. More specifically, f1, R1, and R2 may further satisfy: 1.1<f1/(R1+R2)<1.3.

In an exemplary embodiment, the optical imaging lens assembly may satisfy 0<f3/(f5+f6)<1.5, wherein f3 is an effective focal length of the third lens, f5 is an effective focal length of the fifth lens, and f6 is an effective focal length of the sixth lens. The optical imaging lens assembly satisfies: 0<f3/(f5+f6)<1.5, so as to compress a total length of the optical imaging lens assembly, to achieve a miniaturization of the optical imaging lens assembly, and further to avoid an increase of a tolerance sensitivity of the lens caused by excessive refractive power concentration. More specifically, f3, f5, and f6 may further satisfy: 0.1<f3/(f5+f6)<1.4.

In an exemplary embodiment, the optical imaging lens assembly may satisfy 1.0<(R5+R6)/(R3+R4)<1.5, wherein R5 is a curvature radius of an object-side surface of the third lens, R6 is a curvature radius of an image-side surface of the third lens, R3 is a curvature radius of an object-side surface of the second lens, and R4 is a curvature radius of an image-side surface of the second lens. The optical imaging lens assembly satisfies: 1.0<(R5+R6)/(R3+R4)<1.5, so as to reasonably control a deflection angle of edge light of the optical imaging lens assembly to effectively reduce a sensitivity of the lens. More specifically, R5, R6, R3 and R4 may further satisfy: 1.1<(R5+R6)/(R3+R4)<1.4.

In an exemplary embodiment, the optical imaging lens assembly may satisfy 1.2<(f7−f8)/(R13+R16)<1.8, wherein f7 is an effective focal length of the seventh lens, f8 is an effective focal length of the eighth lens, R13 is a curvature radius of an object-side surface of the seventh lens, and R16 is a curvature radius of an image-side surface of the eighth lens. The optical imaging lens assembly satisfies: 1.2<(f7−f8)/(R13+R16)<1.8, so as to better correct a chromatic aberration, and to improve an imaging quality. Meanwhile, an increase of a tolerance sensitivity of the optical imaging lens assembly caused by excessive refractive power concentration and excessive surface bending is avoided. More specifically, f7, f8, R13 and R16 may further satisfy: 1.3<(f7−f8)/(R13+R16)<1.7.

In an exemplary embodiment, the optical imaging lens assembly may satisfy 1.2<(CT7+CT8)/T78<1.8, wherein CT7 is a center thickness of the seventh lens on the optical axis, CT8 is a center thickness of the eighth lens on the optical axis, and T78 is a spacing distance between the seventh lens and the eighth lens on the optical axis. The optical imaging lens assembly satisfies: 1.2<(CT7+CT8)/T78<1.8, so as to reasonably regulate and control a distortion amount of the optical imaging lens assembly to make a distortion of the lens in a reasonable range. More specifically, CT7, CT8, and T78 may further satisfy: 1.3<(CT7+CT8)/T78<1.7.

In an exemplary embodiment, the optical imaging lens assembly may satisfy 4.1<f34/f567<7.6, wherein f34 is a combined focal length of the third lens and the fourth lens, and f567 is a combined focal length of the fifth lens, the sixth lens and the seventh lens. The optical imaging lens assembly satisfies: 4.1<f34/f567<7.6, so as to favorably control aberration contributions of the two groups of lenses, to favorably balance an aberration generated by an optical element at a front end, and further to make an aberration of the optical imaging lens assembly in a reasonable range. More specifically, f34 and f567 may further satisfy: 4.3<f34/f567<7.5.

In an exemplary embodiment, the optical imaging lens assembly may satisfy 0.7<(SAG61+SAG62)/(SAG51+SAG52)<1.6, wherein SAG61 is a distance from an intersection point of an object-side surface of the sixth lens and the optical axis to an effective radius vertex of the object-side surface of the sixth lens on the optical axis, SAG62 is a distance from an intersection point of an image-side surface of the sixth lens and the optical axis to an effective radius vertex of the image-side surface of the sixth lens on the optical axis, SAG51 is a distance from an intersection point of an object-side surface of the fifth lens and the optical axis to an effective radius vertex of the object-side surface of the fifth lens on the optical axis, and SAG52 is a distance from an intersection point of an image-side surface of the fifth lens and the optical axis to an effective radius vertex of the image-side surface of the fifth lens on the optical axis. The optical imaging lens assembly satisfies: 0.7<(SAG61+SAG62)/(SAG51+SAG52)<1.6, so as to better balance a relationship between a miniaturization of the optical imaging lens assembly and a relative illuminance of an off-axis field of view. More specifically, SAG61, SAG62, SAG51 and SAG52 may further satisfy: 0.8<(SAG61+SAG62)/(SAG51+SAG52)<1.5.

In an exemplary embodiment, the optical imaging lens assembly may satisfy 1.0<CT4/(T45+ET4)<1.6, wherein CT4 is a center thickness of the fourth lens on the optical axis, T45 is a spacing distance between the fourth lens and the fifth lens on the optical axis, and ET4 is an edge thickness of the fourth lens. The optical imaging lens assembly satisfies: 1.0<CT4/(T45+ET4)<1.6, so as to improve machining manufacturability of the first lens and the second lens to reduce forming and manufacturing difficulty. More specifically, CT4, T45, and ET4 may further satisfy: 1.1<CT4/(T45+ET4)<1.5.

In an exemplary embodiment, the optical imaging lens assembly may satisfy 0.8<ET8/(ET5+ET6+ET7)<1.5, wherein ET8 is an edge thickness of the eighth lens, ET5 is an edge thickness of the fifth lens, ET6 is an edge thickness of the sixth lens, and ET7 is an edge thickness of the seventh lens. The optical imaging lens assembly satisfies: 0.8<ET8/(ET5+ET6+ET7)<1.5, so as to effectively control an edge structure of the optical imaging lens group to make the lens compact in structure. More specifically, ET8, ET5, ET6 and ET7 may further satisfy: 0.9<ET8/(ET5+ET6+ET7)<1.4.

In an exemplary embodiment, the optical imaging lens assembly may satisfy 58<V1<70, wherein V1 is an Abbe number of the first lens. The optical imaging lens assembly satisfies: 58<V1<70, such that the optical imaging lens assembly has a smaller chromatic dispersion, so as to improve an imaging quality of the lens.

In an exemplary embodiment, the optical imaging lens assembly may further include an optical filter used for correcting color deviation and/or a protective glass used for protecting a photosensitive element located on the imaging surface.

In an exemplary embodiment, at least one of the first lens to the eighth lens may be a glass lens. The glass has a low thermal expansion coefficient and is less influenced by an environment temperature. The optical imaging lens assembly may be ensured to maintain high image resolution capability in a large temperature change range by reasonably matching materials of the lenses. Exemplarily, the first lens may be made of glass, and the arrangement mode is beneficial for reducing a chromatic dispersion of the optical imaging lens assembly.

The optical imaging lens assembly according to the above embodiment of the disclosure may adopt a plurality of lenses, for example, eight lenses described above. The refractive power and a surface type of each lens, the center thickness of each lens, the on-axis spacing distance between the lenses, etc. are reasonably distributed, thereby effectively reducing a size of the optical imaging lens assembly, reducing sensitivity of the lens, and improving machinability of the lens, which makes the optical imaging lens assembly more beneficial to production and processing and suitable for portable electronic products. The optical imaging lens assembly according to the embodiment of the disclosure also has at least one beneficial effect of high pixel, high imaging quality, compact structure, miniaturization, etc.

In the embodiment of the disclosure, at least one of the mirror surfaces of all lenses is an aspheric mirror surface, that is, at least one mirror surface from the object-side surface of the first lens to the image-side surface of the eighth lens is an aspheric mirror surface. The aspheric lens has the features that the curvature varies continuously from a center of the lens to a periphery of the lens. Different from a spherical lens having a constant curvature from the center of the lens to the periphery of the lens, the aspherical lens has a better feature of a curvature radius and has the advantages of improving distortion aberration and astigmatism aberration. After the aspherical lens is used, aberration occurring during imaging may be eliminated as much as possible, thereby improving the imaging quality. In an embodiment, at least one of the object-side surface and the image-side surface of each of the first lens to the eighth lens is an aspheric mirror surface. In another embodiment, the object-side surface and the image-side surface of each of the first lens to the eighth lens are aspheric mirror surfaces.

However, it should be understood by those skilled in the art that the number of lenses constituting the optical imaging lens assembly may be varied to obtain various results and advantages described in this specification without departing from the claimed technical solution. For example, although described with eight lenses as an example in the embodiment, the optical imaging lens assembly is not limited to including eight lenses. The optical imaging lens assembly may also include other numbers of lenses if desired.

Specific embodiments of the optical imaging lens assembly that may be suitable for use in the above embodiment are described further below with reference to the accompanying drawings.

### Embodiment 1

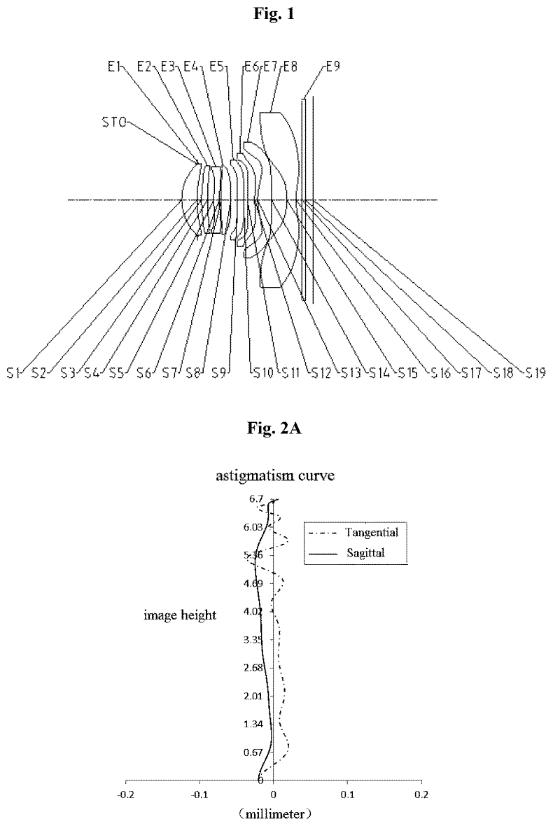

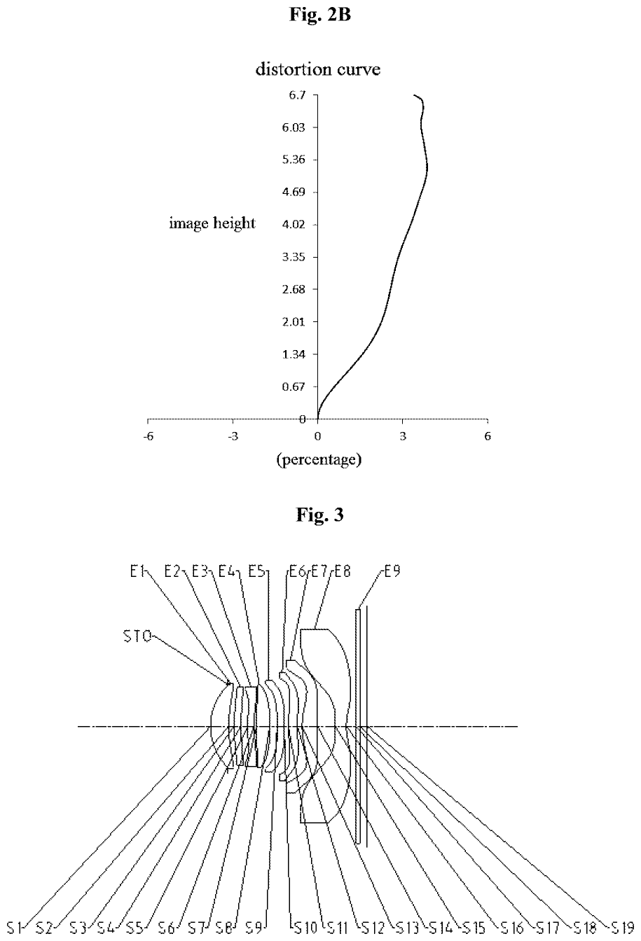

An optical imaging lens assembly according to Embodiment 1 of the disclosure is described below with reference to FIGS. 1-2B. FIG. 1 shows a structural schematic diagram of an optical imaging lens assembly according to Embodiment 1 of the disclosure.

As shown in FIG. 1, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9. The first lens E1 is used to constitute a first lens group, and the first lens group has a positive refractive power; and the second lens E2 to the eighth lens E8 are used to constitute a second lens group, and the second lens group has a positive refractive power.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a convex surface. The eighth lens E8 has a negative refractive power, an object-side surface S15 thereof is a concave surface, and an image-side surface S16 thereof is a concave surface. The optical filter E9 has an object-side surface S17 and an image-side surface S18. The optical imaging lens assembly has an imaging surface S19, and light from an object sequentially passes through each surface from S1 to S18 and is finally imaged on the imaging surface S19.

Table 1 shows a table of basic parameters of the optical imaging lens assembly of Embodiment 1, wherein units of the curvature radius, the thickness, and the focal length are all millimeters (mm).

TABLE 1

| | | | | Material | | | |
|---|---|---|---|---|---|---|---|
| Surface | Surface | Curvature | | Refractive | Abbe | Focal | Conic |
| number | type | radius | Thickness | index | number | length | coefficient |
| OBJ | Spherical | Infinity | Infinity | | | | |
| STO | Spherical | Infinity | −0.9751 | | | | |
| S1 | Aspheric | 3.1253 | 0.9755 | 1.52 | 67.1 | 10.8 | −0.1168 |
| S2 | Aspheric | 6.2683 | 0.2891 | | | | −28.1604 |
| S3 | Aspheric | 6.4973 | 0.3800 | 1.54 | 56.1 | 52.73 | 5.8859 |
| S4 | Aspheric | 8.2197 | 0.4155 | | | | 2.6094 |
| S5 | Aspheric | 11.1075 | 0.3500 | 1.66 | 20.4 | −64.32 | −99.0000 |
| S6 | Aspheric | 8.7085 | 0.1211 | | | | −72.5697 |
| S7 | Aspheric | 60.0494 | 0.6244 | 1.54 | 56.1 | 27.74 | −32.9902 |
| S8 | Aspheric | −20.1550 | 0.4265 | | | | −23.5730 |
| S9 | Aspheric | 22.8639 | 0.3800 | 1.66 | 20.4 | −25.77 | 68.4097 |
| S10 | Aspheric | 9.7360 | 0.2298 | | | | −99.0000 |
| S11 | Aspheric | 5.7115 | 0.4761 | 1.54 | 56.1 | −23.68 | −99.0000 |
| S12 | Aspheric | 3.8441 | 0.1867 | | | | −27.3675 |
| S13 | Aspheric | 2.9124 | 0.8880 | 1.54 | 56.1 | 4.57 | −5.8507 |
| S14 | Aspheric | −15.5435 | 0.9673 | | | | −6.6743 |
| S15 | Aspheric | −9.3781 | 0.6000 | 1.54 | 56.1 | −4.53 | 1.7549 |
| S16 | Aspheric | 3.4342 | 0.4017 | | | | −8.0311 |
| S17 | Spherical | Infinity | 0.2100 | 1.52 | 64.2 | | |
| S18 | Spherical | Infinity | 0.4782 | | | | |
| S19 | Spherical | Infinity | | | | | |

In Embodiment 1, f is a total effective focal length of the optical imaging lens assembly, and f is 6.40 mm, TTL is a distance from the object-side surface S1 of the first lens E1 to the imaging surface S19 on the optical axis, and TTL is 8.40 mm, ImgH is a half of a diagonal length of an effective pixel region on the imaging surface S19, and ImgH is 6.70 mm.

In Embodiment 1, both of the object-side surface and the image-side surface of any one of the first lens E1 to the eighth lens E8 are aspheric surfaces, and the surface type x of each aspheric lens may be defined by, but not limited to, the following aspherical formula:

$$x = \frac{{ch}^{3}}{1 + \sqrt{1 - ( k + 1 ) {c}^{3} {h}^{2}}} + \sum {Aih}^{i} \qquad ( 1 )$$

wherein xis a vector height of a distance between the aspheric surface and a vertex of the aspheric surface when the aspheric surface is located at a position with the height h in an optical axis direction; c is paraxial curvature of the aspheric surface, c=1/R (that is, the paraxial curvature c is a paraxial of curvature radius R in Table 1 above); k is a conic coefficient; and Ai is a correction coefficient of the i-th order of the aspheric surface. Table 2 below shows high-order coefficients A4, A6, A8, A10, A12, A14, A16, A18 and A20 that may be used for each of the aspheric mirror surfaces S1-S8 in Embodiment 1.

TABLE 2

| Surface | | | | | |
|---|---|---|---|---|---|
| number | A4 | A6 | AB | A10 | A12 |
| S1 | 1.2733E−04 | 4.6191E−04 | −5.7662E−01 | 5.4305E−04 | −2.9214E−04 |
| S2 | 9.0407E−03 | −3.9124E−03 | 2.0254E−04 | 1.7880E−03 | −9.7671E−04 |
| S3 | −1.6758E−02 | 1.2408E−03 | −3.6821E−03 | 4.0734E−03 | −2.3956E−03 |
| S4 | −1.1180E−02 | −2.7120E−03 | 3.5633E−03 | −3.6504E−03 | 2.7630E−03 |
| S3 | −3.6757E−03 | −7.2703E−03 | 1.0385E−03 | 1.3595E−04 | −1.3468E−04 |
| S6 | 8.1076E−03 | −5.0882E−03 | −1.1853E−03 | 2.0293E−03 | −1.1500E−03 |
| S7 | −1.7606E−03 | 6.9029E−03 | −5.9314E−03 | 3.9953E−03 | −1.9144E−03 |
| S8 | −1.7452E−02 | 9.4089E−03 | −9.4398E−03 | 6.9521E−03 | −3.4213E−03 |
| S9 | −3.9011E−02 | 2.3970E−02 | −2.0900E−02 | 1.3396E−02 | −5.7282E−03 |
| S10 | −4.4055E−02 | 3.4447E−02 | −2.6195E−02 | 1.3198E−02 | −4.2390E−03 |
| S11 | −2.3851E−02 | 1.8080E−02 | −8.9978E−03 | 1.3948E−03 | 4.2647E−04 |
| S12 | −6.7661E−02 | 3.8950E−02 | −1.6756E−02 | 4.1647E−03 | −5.6686E−04 |
| S13 | −3.2308E−02 | 1.6668E−02 | −6.5658E−03 | 1.5807E−03 | −2.4984E−04 |
| S14 | 2.2622E−02 | −1.1120E−02 | 3.3854E−03 | −7.2375E−04 | 1.0298E−04 |
| S15 | −4.4502E−02 | 4.2346E−03 | 2.2126E−04 | −3.2748E−05 | −1.6854E−06 |
| S16 | −2.5414E−02 | 4.3851E−03 | −4.9753E−04 | 4.0262E−05 | −2.3734E−06 |

| Surface | | | | |
|---|---|---|---|---|
| number | A14 | A16 | A18 | A20 |
| S1 | 9.5118E−05 | −1.8530E−05 | 1.9955E−06 | −9.3323E−08 |
| S2 | 3.9819E−04 | −9.0886E−05 | 1.1035E+00 | −5.5522E−07 |
| S3 | 8.6942E−04 | −1.9092E−04 | 2.3097E−05 | −1.1698E−06 |
| S4 | −1.2535E−03 | 3.3416E−04 | −4.8767E−05 | 3.0318E−06 |
| S3 | 8.9976E−05 | −3.8800E−05 | 7.6942E−06 | −5.3517E−07 |
| S6 | 4.1786E−04 | −1.0262E−04 | 1.4617E−05 | −8.6106E−07 |
| S7 | 6.0662E−04 | −1.2265E−04 | 1.4013E−05 | −6.7136E−07 |
| S8 | 1.0631E−03 | −1.9903E−04 | 2.0358E−05 | −8.7436E−07 |
| S9 | 1.5737E−03 | −2.7059E−04 | 2.6553E−05 | −1.1269E−06 |
| S10 | 8.6155E−04 | −1.0851E−04 | 7.7649E−06 | −2.4040E−07 |
| S11 | −2.3359E−04 | 4.1041E−05 | −3.9390E−06 | 1.3958E−07 |
| S12 | 2.8887E−05 | 2.2327E−06 | −3.5569E−07 | 1.2809E−08 |
| S13 | 2.4273E−05 | −1.3690E−06 | 4.2397E−08 | −5.9852E−10 |
| S14 | −1.0075E−05 | 6.7423E−07 | −2.7584E−08 | 5.0451E−10 |
| S15 | 3.8922E−07 | −2.2306E−08 | 5.6828E−10 | −5.5920E−12 |
| S16 | 9.8899E−08 | −2.7145E−09 | 4.3308E−11 | −3.0070E−13 |

FIG. 2A shows an astigmatism curve of the optical imaging lens assembly of Embodiment 1, which represents a curvature of to image surface and a curvature of sagittal image surface. FIG. 2B shows a distortion curve of the optical imaging lens assembly of Embodiment 1, which represents distortion magnitude values corresponding to different image heights. According to FIGS. 2A-2B, it can be seen that the optical imaging lens assembly provided in Embodiment 1 is capable of achieving good imaging quality.

### Embodiment 2

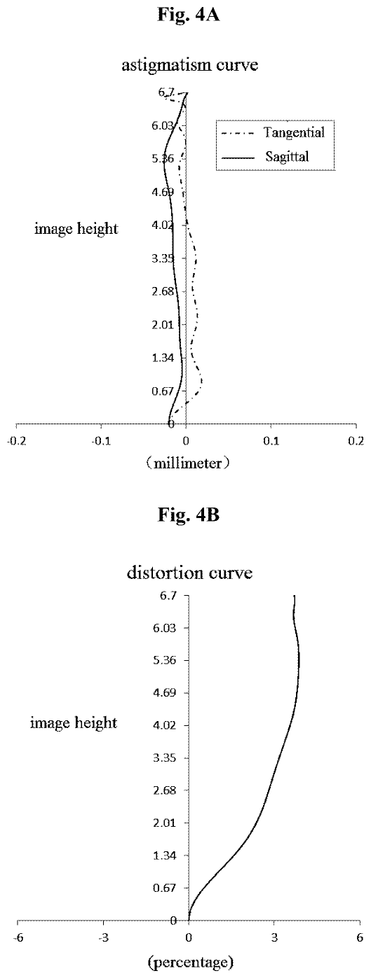

An optical imaging lens assembly according to Embodiment 2 of the disclosure is described below with reference to FIGS. 3-4B. In this embodiment and the following embodiments, parts of the description similar to Embodiment 1 will be omitted for the sake of brevity. FIG. 3 shows a structural schematic diagram of the optical imaging lens assembly according to Embodiment 2 of the disclosure.

As shown in FIG. 3, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9. The first lens E1 is used to constitute a first lens group, and the first lens group has a positive refractive power; and the second lens E2 to the eighth lens E8 are used to constitute a second lens group, and the second lens group has a positive refractive power.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a concave surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a convex surface. The eighth lens E8 has a negative refractive power, an object-side surface S15 thereof is a concave surface, and an image-side surface S16 thereof is a concave surface. The optical filter E9 has an object-side surface S17 and an image-side surface S18. The optical imaging lens assembly has an imaging surface S19, and light from an object sequentially passes through each surface from S1 to S18 and is finally imaged on the imaging surface S19.

In Embodiment 2, f is a total effective focal length of the optical imaging lens assembly, and f is 6.51 mm, TTL is a distance from the object-side surface S1 of the first lens E1 to the imaging surface S19 on the optical axis, and TTL is 8.60 mm, ImgH is a half of a diagonal length of an effective pixel region on the imaging surface S19, and ImgH is 6.70 mm.

Table 3 shows a table of basic parameters of the optical imaging lens assembly of Embodiment 2, wherein units of the curvature radius, the thickness, and the focal length are all millimeters (mm). Table 4 shows high-order coefficients that may be used for each aspheric mirror surface in Embodiment 2, wherein each aspheric surface type may be defined by formula (1) provided in Embodiment 1 above.

TABLE 3

| | | | | Material | | | |
|---|---|---|---|---|---|---|---|
| Surface | Surface | Curvature | | Refractive | Abbe | Focal | Conic |
| number | type | radius | Thickness | index | number | length | coefficient |
| OBJ | Spherical | Infinity | Infinity | | | | |
| STO | Spherical | Infinity | −0.9700 | | | | |
| S1 | Aspheric | 3.1956 | 0.9935 | 1.51 | 60.4 | 11.47 | −0.1797 |
| S2 | Aspheric | 6.2638 | 0.2954 | | | | −18.6712 |
| S3 | Aspheric | 6.3671 | 0.3803 | 1.54 | 56.1 | 51.59 | 5.3791 |
| S4 | Aspheric | 8.0554 | 0.3763 | | | | −7.2885 |
| S5 | Aspheric | 10.0853 | 0.3500 | 1.66 | 20.4 | −50.45 | −49.3173 |
| S6 | Aspheric | 7.6486 | 0.1304 | | | | −38.4852 |
| S7 | Aspheric | 37.6879 | 0.7319 | 1.54 | 56.1 | 20.66 | 52.8358 |
| S8 | Aspheric | −15.9719 | 0.4085 | | | | 1.9376 |
| S9 | Aspheric | −37.5129 | 0.3800 | 1.66 | 20.4 | −29.43 | 72.9339 |
| S10 | Aspheric | 41.1807 | 0.2367 | | | | −32.0039 |
| S11 | Aspheric | 6.4445 | 0.4859 | 1.54 | 56.1 | −261.20 | −99.0000 |
| S12 | Aspheric | 6.0015 | 0.2684 | | | | −30.1496 |
| S13 | Aspheric | 3.7417 | 0.8474 | 1.54 | 56.1 | 6.13 | −4.0379 |
| S14 | Aspheric | −29.1558 | 0.9802 | | | | 60.3280 |
| S15 | Aspheric | −30.5919 | 0.6000 | 1.54 | 56.1 | −4.73 | 34.7174 |
| S16 | Aspheric | 2.8352 | 0.5425 | | | | −7.7104 |
| S17 | Spherical | Infinity | 0.2100 | 1.52 | 64.2 | | |
| S18 | Spherical | Infinity | 0.3823 | | | | |
| S19 | Spherical | Infinity | | | | | |

TABLE 4

| Surface | | | | | |
|---|---|---|---|---|---|
| number | A4 | A6 | A8 | A10 | A12 |
| S1 | 6.2075E−04 | −1.3533E−06 | 2.1103E−04 | −1.7213E−04 | 9.6377E−05 |
| S2 | 3.9404E−03 | −2.7669E−03 | 1.5871E−03 | −8.9773E−04 | 3.6039E−04 |
| S3 | −1.8261E−02 | −5.2188E−04 | −3.0756E−04 | 3.9367E−04 | −1.8266E−05 |
| S4 | −1.0134E−02 | −3.5917E−03 | 4.7032E−03 | −4.4394E−03 | 3.0561E−03 |
| S5 | −5.8071E−03 | −3.3491E−03 | −2.4769E−03 | 3.2203E−03 | −1.9148E−03 |
| S6 | 6.8891E−03 | −3.2560E−03 | −1.4891E−03 | 1.8625E−03 | −8.6298E−04 |
| S7 | 7.2473E−05 | 1.1291E−03 | 2.5846E−04 | −7.4125E−04 | 5.5381E−04 |
| S8 | −1.3728E−02 | 3.4276E−03 | −4.1614E−03 | 3.1781E−03 | −1.5255E−03 |
| S9 | −3.0470E−02 | 1.5263E−02 | −1.4707E−02 | 9.5444E−03 | −3.9006E−03 |
| S10 | −3.7200E−02 | 1.7456E−02 | −1.2541E−02 | 6.2303E−03 | −1.9461E−03 |
| S11 | 6.7147E−03 | −1.3631E−02 | 1.0913E−02 | −5.9202E−03 | 2.0165E−03 |
| S12 | −2.5579E−02 | −1.4582E−03 | 5.9728E−03 | −3.3588E−03 | 9.7527E−04 |
| S13 | −2.8693E−03 | −1.0822E−02 | 5.8559E−03 | −1.9025E−03 | 3.9291E−04 |
| S14 | 2.5130E−02 | −1.2878E−02 | 3.1154E−03 | −4.6025E−04 | 4.0523E−05 |
| S15 | −5.3870E−02 | 6.1584E−03 | −1.6105E−04 | −9.0230E−06 | 1.8494E−08 |
| S16 | −2.5093E−02 | 4.0861E−03 | −4.2264E−04 | 2.9854E−05 | −1.1861E−06 |

| Surface | | | | |
|---|---|---|---|---|
| number | A14 | A16 | A18 | A20 |
| S1 | −3.2248E−05 | 6.1547E−06 | −6.0119E−07 | 2.1067E−08 |
| S2 | −9.2197E−05 | 1.4203E−05 | −1.2188E−06 | 4.5452E−08 |
| S3 | −4.9229E−05 | 1.8167E−05 | −2.8081E−06 | 1.7537E−07 |
| S4 | −1.2702E−03 | 3.0959E−04 | −4.1182E−05 | 2.3242E−06 |
| S5 | 7.0251E−04 | −1.6081E−04 | 2.0635E−05 | −1.1106E−06 |
| S6 | 2.4201E−04 | −4.6453E−05 | 5.5220E−06 | −2.8539E−07 |
| S7 | −2.0552E−04 | 3.9176E−05 | −3.6869E−06 | 1.3618E−07 |
| S8 | 4.5310E−04 | −8.0669E−05 | 7.9380E−06 | −3.3607E−07 |
| S9 | 1.0101E−03 | −1.6221E−04 | 1.4720E−05 | −5.7498E−07 |
| S10 | 3.8415E−04 | −4.7053E−05 | 3.2571E−06 | −9.6397E−08 |
| S11 | −4.2987E−04 | 5.5578E−05 | −3.9902E−06 | 1.2160E−07 |
| S12 | −1.6762E−04 | 1.7080E−05 | −9.4896E−07 | 2.2101E−08 |
| S13 | −5.2597E−05 | 4.2757E−06 | −1.8659E−07 | 3.3075E−09 |
| S14 | −2.1882E−06 | 7.6391E−08 | −1.7052E−09 | 1.8732E−11 |
| S15 | 7.4306E−08 | −4.6112E−09 | 1.1223E−10 | −1.0006E−12 |
| S16 | 5.1581E−08 | −1.1863E−09 | 1.6010E−11 | −9.4614E−14 |

FIG. 4A shows an astigmatism curve of the optical imaging lens assembly of Embodiment 2, which represents a curvature of tangential image surface and a curvature of sagittal image surface. FIG. 4B shows a distortion curve of the optical imaging lens assembly of Embodiment 2, which represents distortion magnitude values corresponding to different image heights. According to FIGS. 4A-4B, it can be seen that the optical imaging lens assembly provided in Embodiment 2 is capable of achieving good imaging quality.

### Embodiment 3

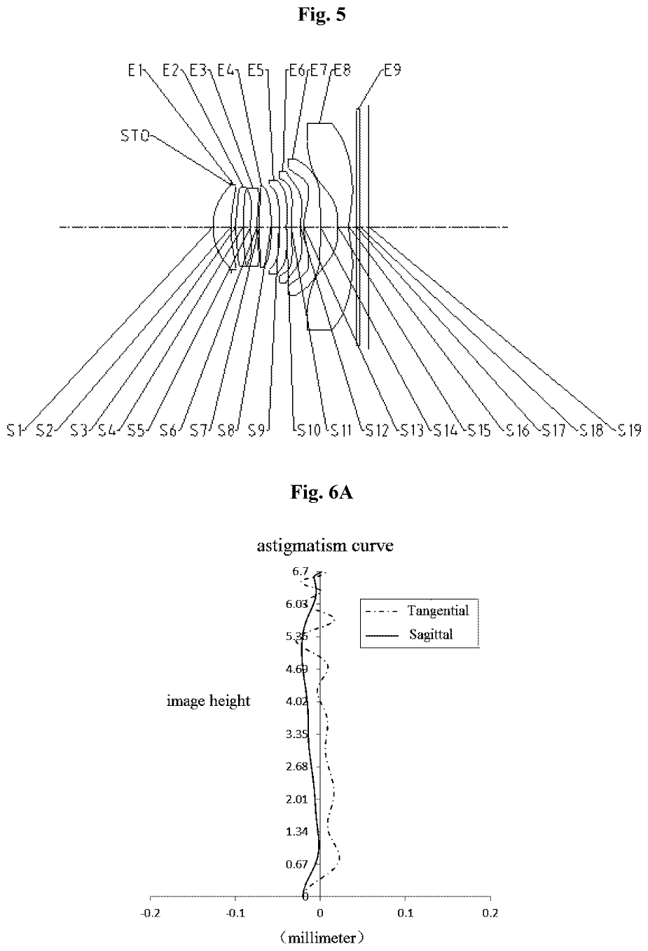

An optical imaging lens assembly according to Embodiment 3 of the disclosure is described below with reference to FIGS. 5-6B. FIG. 5 shows a structural schematic diagram of the optical imaging lens assembly according to Embodiment 3 of the disclosure.

As shown in FIG. 5, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9. The first lens E1 is used to constitute a first lens group, and the first lens group has a positive refractive power; and the second lens E2 to the eighth lens E8 are used to constitute a second lens group, and the second lens group has a positive refractive power.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a convex surface. The eighth lens E8 has a negative refractive power, an object-side surface S15 thereof is a concave surface, and an image-side surface S16 thereof is a concave surface. The optical filter E9 has an object-side surface S17 and an image-side surface S18. The optical imaging lens assembly has an imaging surface S19, and light from an object sequentially passes through each surface from S1 to S18 and is finally imaged on the imaging surface S19.

In Embodiment 3, f is a total effective focal length of the optical imaging lens assembly, and f is 6.45 mm, TTL is a distance from the object-side surface S1 of the first lens E1 to the imaging surface S19 on the optical axis, and TTL is 8.50 mm, ImgH is a half of a diagonal length of an effective pixel region of a photosensitive element on the imaging surface S19, and ImgH is 6.70 mm.

Table 5 shows a table of basic parameters of the optical imaging lens assembly of Embodiment 3, wherein units of the curvature radius, the thickness, and the focal length are all millimeters (mm). Table 6 shows high-order coefficients that may be used for each aspheric mirror surface in Embodiment 3, wherein each aspheric surface type may be defined by formula (1) provided in Embodiment 1 above.

TABLE 5

| | | | | Material | | | |
|---|---|---|---|---|---|---|---|
| Surface | Surface | Curvature | | Refractive | Abbe | Focal | Conic |
| number | type | radius | Thickness | index | number | length | coefficient |
| OBJ | Spherical | Infinity | Infinity | | | | |
| STO | Spherical | Infinity | −0.9872 | | | | |
| S1 | Aspheric | 3.1353 | 0.9840 | 1.52 | 64.2 | 10.99 | −0.1067 |
| S2 | Aspheric | 62287 | 0.2716 | | | | −29.7061 |
| S3 | Aspheric | 6.4958 | 0.3859 | 1.54 | 56.1 | 50.11 | 5.8140 |
| S4 | Aspheric | 8.3420 | 0.4164 | | | | 2.9893 |
| S5 | Aspheric | 11.0610 | 0.3500 | 1.66 | 20.4 | −58.35 | −94.8799 |
| S6 | Aspheric | 8.5005 | 0.1239 | | | | −63.1460 |
| S7 | Aspheric | 55.21S1 | 0.6383 | 1.54 | 56.1 | 27.48 | 98.6999 |
| S8 | Aspheric | −20.4890 | 0.4300 | | | | −36.9013 |
| S9 | Aspheric | 23.2430 | 0.4068 | 1.66 | 20.4 | −25.40 | 68.9773 |
| S10 | Aspheric | 9.7189 | 0.2542 | | | | −98.0647 |
| S11 | Aspheric | 5.7366 | 0.5116 | 1.54 | 56.1 | −25.10 | −96.8574 |
| S12 | Aspheric | 3.9158 | 0.1801 | | | | −27.1320 |
| S13 | Aspheric | 2.9313 | 0.9000 | 1.54 | 56.1 | 4.57 | −6.0412 |
| S14 | Aspheric | −14.7639 | 0.9500 | | | | −4.5330 |
| S15 | Aspheric | −9.3775 | 0.6000 | 1.54 | 56.1 | −4.54 | 1.7184 |
| S16 | Aspheric | 3.4447 | 0.4056 | | | | −7.5661 |
| S17 | Spherical | Infinity | 0.2100 | 1.52 | 64.2 | | |
| S18 | Spherical | Infinity | 0.4821 | | | | |
| S19 | Spherical | Infinity | | | | | |

TABLE 6

| Surface | | | | | |
|---|---|---|---|---|---|
| number | A4 | A6 | A8 | A10 | A12 |
| S1 | 2.1149E−04 | 4.2641E−04 | −5.6873E−04 | 5.5896E−04 | −3.0083E−04 |
| S2 | 9.3691E−03 | −3.9756E−03 | −2.6311E−04 | 1.6869E−03 | −1.2426E−03 |
| S3 | −1.7241E−02 | 1.2600E−03 | −3.6947E−03 | 4.0725E−03 | −2.3664E−03 |
| S4 | −1.1178E−02 | −3.1454E−03 | 4.5389E−03 | −4.7530E−03 | 3.4871E−03 |
| S5 | −3.8368E−03 | −6.3884E−03 | −2.9157E−04 | 1.2977E−03 | −7.3646E−04 |
| S6 | 7.2795E−03 | −2.9911E−03 | −3.5572E−03 | 3.7653E−03 | −1.9699E−03 |
| S7 | −2.0384E−03 | 8.2016E−03 | −7.5826E−03 | 5.2519E−03 | −2.5175E−03 |
| S8 | −1.8006E−02 | 1.0490E−02 | −1.0434E−02 | 7.4699E−03 | −3.5716E−03 |
| S9 | −4.0561E−02 | 2.7095E−02 | −2.3569E−02 | 1.4816E−02 | −6.2582E−03 |
| S10 | −4.5434E−02 | 3.5704E−02 | −2.6358E−02 | 1.3054E−02 | −4.1855E−03 |
| S11 | −2.0795E−02 | 1.4314E−02 | −6.6776E−03 | 9.1717E−04 | 3.3625E−04 |
| S12 | −6.5561E−02 | 3.6632E−02 | −1.5320E−02 | 3.7388E−03 | −5.1339E−04 |
| S13 | −3.2782E−02 | 1.7092E−02 | −6.4930E−03 | 1.4916E−03 | −2.2588E−04 |
| S14 | 2.1223E−02 | −1.0552E−02 | 3.4134E−03 | −7.9166E−04 | 1.2168E−04 |
| S15 | −4.3553E−02 | 3.9453E−03 | 2.5188E−04 | −3.6834E+00 | −1.0113E−06 |
| S16 | −2.5285E−02 | 4.4328E−03 | −5.2026E−04 | 4.4169E−05 | −2.7138E−06 |

| Surface | | | | |
|---|---|---|---|---|
| number | A14 | A16 | A18 | A20 |
| S1 | 9.6326E−05 | −1.8331E−05 | 1.9299E−06 | −8.9001E−08 |
| S2 | 4.7715E−04 | −1.0420E−04 | 1.2194E−05 | −5.9404E−07 |
| S3 | 8.4579E−04 | −1.8252E−04 | 2.1659E−05 | −1.0737E−06 |
| S4 | −1.5348E−03 | 3.9785E−04 | −5.6466E−05 | 3.4099E−06 |
| S5 | 2.7617E−04 | −7.1691E−05 | 1.0614E−05 | −6.3573E−07 |
| S6 | 6.5997E−04 | −1.4480E−04 | 1.8506E−05 | −1.0041E−06 |
| S7 | 7.8623E−04 | −1.5440E−04 | 1.7048E−05 | −7.9190E−07 |
| S8 | 1.0870E−03 | −2.0060E−04 | 2.0304E−05 | −8.6444E−07 |
| S9 | 1.7069E−03 | −2.9067E−04 | 2.8083E−05 | −1.1670E−06 |
| S10 | 8.5653E−04 | −1.0881E−04 | 7.8311E−06 | −2.4275E−07 |
| S11 | −1.6714E−04 | 3.0098E−05 | −2.5910E−06 | 8.8593E−08 |
| S12 | 3.0829E−05 | 8.7838E−07 | −2.1411E−07 | 7.9297E−09 |
| S13 | 2.1199E−05 | −1.1613E−06 | 3.5175E−08 | −4.9269E−10 |
| S14 | 1.2575E−05 | 8.5599E−07 | −3.4440E−08 | 6.0924E−10 |
| S15 | 3.2485E−07 | −1.9078E−08 | 4.8674E−10 | −4.7671E−12 |
| S16 | 1.1535E−07 | −3.1577E−09 | 4.9435E−11 | −3.3365E−13 |

FIG. 6A shows an astigmatism curve of the optical imaging lens assembly of Embodiment 3, which represents a curvature of tangential image surface and a curvature of sagittal image surface. FIG. 6B shows a distortion curve of the optical imaging lens assembly of Embodiment 3, which represents distortion magnitude values corresponding to different image heights. According to FIGS. 6A-6B, it can be seen that the optical imaging lens assembly provided in Embodiment 3 is capable of achieving good imaging quality.

### Embodiment 4

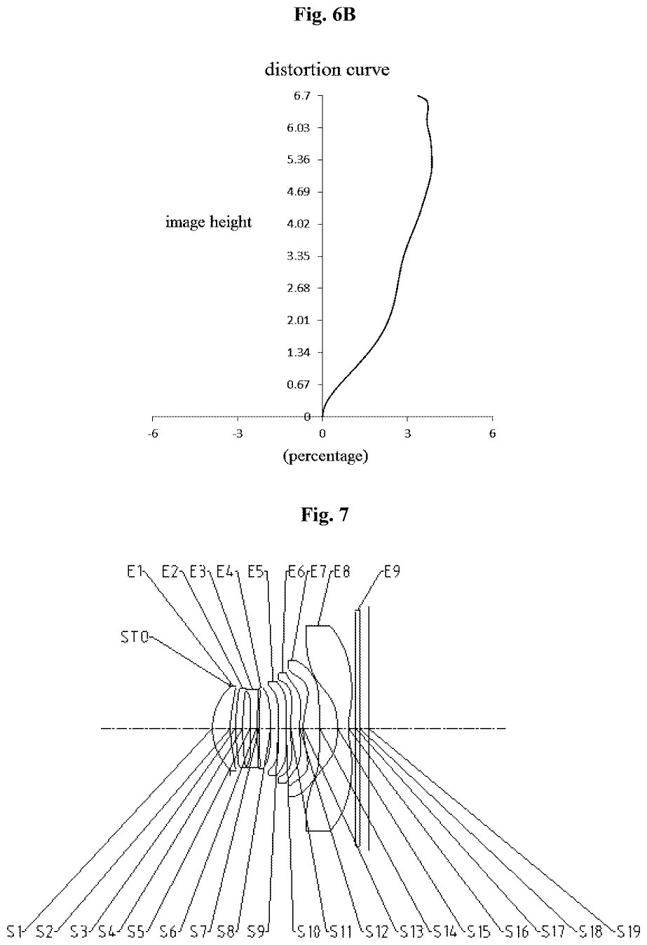

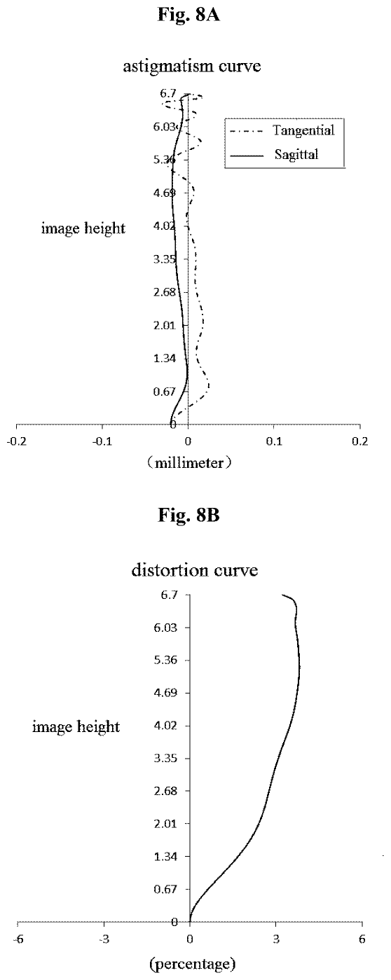

An optical imaging lens assembly according to Embodiment 4 of the disclosure is described below with reference to FIGS. 7-8B. FIG. 7 shows a structural schematic diagram of the optical imaging lens assembly according to Embodiment 4 of the disclosure.

As shown in FIG. 7, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9. The first lens E1 is used to constitute a first lens group, and the first lens group has a positive refractive power; and the second lens E2 to the eighth lens E8 are used to constitute a second lens group, and the second lens group has a positive refractive power.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a convex surface. The eighth lens E8 has a negative refractive power, an object-side surface S15 thereof is a concave surface, and an image-side surface S16 thereof is a concave surface. The optical filter E9 has an object-side surface S17 and an image-side surface S18. The optical imaging lens assembly has an imaging surface S19, and light from an object sequentially passes through each surface from S1 to S18 and is finally imaged on the imaging surface S19.

In Embodiment 4, f is a total effective focal length of the optical imaging lens assembly, and f is 6.44 mm, TTL is a distance from the object-side surface S1 of the first lens E1 to the imaging surface S19 on the optical axis, and TTL is 8.49 mm, ImgH is a half of a diagonal length of an effective pixel region on the imaging surface S19, and ImgH is 6.70 mm.

Table 7 shows a table of basic parameters of the optical imaging lens assembly of Embodiment 4, wherein units of the curvature radius, the thickness, and the focal length are all millimeters (mm). Table 8 shows high-order coefficients that may be used for each aspheric mirror surface in Embodiment 4, wherein each aspheric surface type may be defined by formula (1) provided in Embodiment 1 above.

TABLE 7

| | | | | Material | | | |
|---|---|---|---|---|---|---|---|
| Surface | Surface | Curvature | | Refractive | Abbe | Focal | Conic |
| number | type | radius | Thickness | index | number | length | coefficient |
| OBJ | Spherical | Infinity | Infinity | | | | |
| STO | Spherical | Infinity | −0.9829 | | | | |
| S1 | Aspheric | 3.1413 | 0.9785 | 1.52 | 59.5 | 10.92 | −0.1084 |
| S2 | Aspheric | 6.2149 | 0.2739 | | | | −29.4639 |
| S3 | Aspheric | 6.4973 | 0.3848 | 1.54 | 56.1 | 50.5 | 5.8166 |
| S4 | Aspheric | 8.3247 | 0.4152 | | | | 3.0244 |
| S5 | Aspheric | 11.1070 | 0.3500 | 1.66 | 20.4 | −57.72 | −94.3345 |
| S6 | Aspheric | 8.5080 | 0.1250 | | | | −62.9578 |
| S7 | Aspheric | 55.7315 | 0.6373 | 1.54 | 56.1 | 27.70 | 99.0000 |
| S8 | Aspheric | −20.6463 | 0.4247 | | | | −36.4723 |
| S9 | Aspheric | 23.3014 | 0.4144 | 1.66 | 20.4 | −25.44 | 68.6270 |
| S10 | Aspheric | 9.7384 | 0.2453 | | | | −99.0000 |
| S11 | Aspheric | 5.7107 | 0.4987 | 1.54 | 56.1 | −25.27 | −97.2347 |
| S12 | Aspheric | 3.9137 | 0.1858 | | | | −26.4971 |
| S13 | Aspheric | 2.9586 | 0.9000 | 1.54 | 56.1 | 4.59 | −6.1298 |
| S14 | Aspheric | −14.6376 | 0.9604 | | | | −5.3907 |
| S15 | Aspheric | −9.3883 | 0.6000 | 1.54 | 56.1 | −4.60 | 1.7068 |
| S16 | Aspheric | 3.4985 | 0.4045 | | | | −7.7332 |
| S17 | Spherical | Infinity | 0.2100 | 1.52 | 64.2 | | |
| S18 | Spherical | Infinity | 0.4810 | | | | |
| S19 | Spherical | Infinity | | | | | |

TABLE 8

| Surface | | | | | |
|---|---|---|---|---|---|
| number | A4 | A6 | A8 | A10 | A12 |
| S1 | 1.3482E−04 | 6.3875E−04 | −7.9560E−04 | 6.9202E−04 | −3.4787E−04 |
| S2 | 9.5356E−03 | −4.1646E−03 | −5.1359E−05 | 1.5069E−03 | −1.1458E−03 |
| S3 | −1.7016E−02 | 7.7221E−04 | −3.1272E−03 | 3.6131E−03 | −2.1226E−03 |
| S4 | −1.1103E−02 | −3.2151E−03 | 4.4538E−03 | −4.5917E−03 | 3.3720E−03 |
| S5 | −3.8513E−03 | −6.3694E−03 | −4.0676E−04 | 1.4687E−03 | −8.3607E−04 |
| S6 | 7.2550E−03 | −2.8266E−03 | −3.9971E−03 | 4.1469E−03 | −2.1212E−03 |
| S7 | −2.0376E−03 | 8.4035E−03 | −8.0787E−03 | 5.6339E−03 | −2.6545E−03 |
| S8 | −1.8280E−02 | 1.0875E−02 | −1.0837E−02 | 7.7665E−03 | −3.7136E−03 |
| S9 | −4.0059E−02 | 2.6034E−02 | −2.2717E−02 | 1.4491E−02 | −6.2239E−03 |
| S10 | −4.4594E−02 | 3.4125E−02 | −2.5041E−02 | 1.2391E−02 | −3.9765E−03 |
| S11 | −2.0755E−02 | 1.3957E−02 | −6.2698E−03 | 6.8111E−04 | 4.1597E−04 |
| S12 | −6.5642E−02 | 3.7090E−02 | −1.5754E−02 | 3.9682E−03 | −5.8368E−04 |
| S13 | −3.1711E−02 | 1.5601E−02 | −5.7852E−03 | 1.2739E−03 | −1.8089E−04 |
| S14 | 2.0304E−02 | −1.0196E−02 | 3.1741E−03 | −7.1356E−04 | 1.0941E−04 |
| S15 | −4.3428E−02 | 4.2369E−03 | 1.2894E−04 | −1.6782E−05 | −2.7728E−06 |
| S16 | −2.4569E−02 | 4.1817E−03 | −4.6770E−04 | 3.7625E−05 | −2.2384E−06 |

| Surface | | | | |
|---|---|---|---|---|
| number | A14 | A16 | A18 | A20 |
| S1 | 1.0644E−04 | −1.9597E−05 | 2.0099E−06 | −9.0661E−08 |
| S2 | 4.4524E−04 | −9.7938E−05 | 1.1523E−05 | −5.6375E−07 |
| S3 | 7.6514E−04 | −1.6656E−04 | 1.9930E−05 | −9.9499E−07 |
| S4 | −1.4866E−03 | 3.8558E−04 | 5.4733E−05 | 3.3059E−06 |
| S5 | 3.0602E−04 | −7.6428E−05 | 1.1029E−05 | −6.4792E−07 |
| S6 | 6.8990E−04 | −1.4738E−04 | 1.8516E−05 | −9.9603E−07 |
| S7 | 8.1132E−04 | −1.5646E−04 | 1.7053E−05 | −7.8546E−07 |
| S8 | 1.1304E−03 | −2.0865E−04 | 2.1124E−05 | −8.9939E−07 |
| S9 | 1.7249E−03 | −2.9796E−04 | 2.9127E−05 | −1.2214E−06 |
| S10 | 8.1564E−04 | −1.0402E−04 | 7.5251E−06 | −2.3459E−07 |
| S11 | −1.8386E−04 | 3.2259E−05 | −2.7494E−06 | 9.3619E−08 |
| S12 | 4.3695E−05 | −5.0869E−07 | −1.3295E−07 | 5.9439E−09 |
| S13 | 1.5532E−05 | −7.4987E−07 | 1.9200E−08 | −2.3183E−10 |
| S14 | −1.1473E−05 | 7.9250E−07 | −3.2064E−08 | 5.6496E−10 |
| S15 | 4.1603E−07 | −2.1860E−08 | 5.3284E−10 | −5.0847E−12 |
| S16 | 9.4792E−08 | −2.6358E−09 | 4.2297E−11 | −2.9341E−13 |

FIG. 8A shows an astigmatism curve of the optical imaging lens assembly of Embodiment 4, which represents a curvature of to image surface and a curvature of sagittal image surface. FIG. 8B shows a distortion curve of the optical imaging lens assembly of Embodiment 4, which represents distortion magnitude values corresponding to different image heights. According to FIGS. 8A-8B, it can be seen that the optical imaging lens assembly provided in Embodiment 4 is capable of achieving good imaging quality.

### Embodiment 5

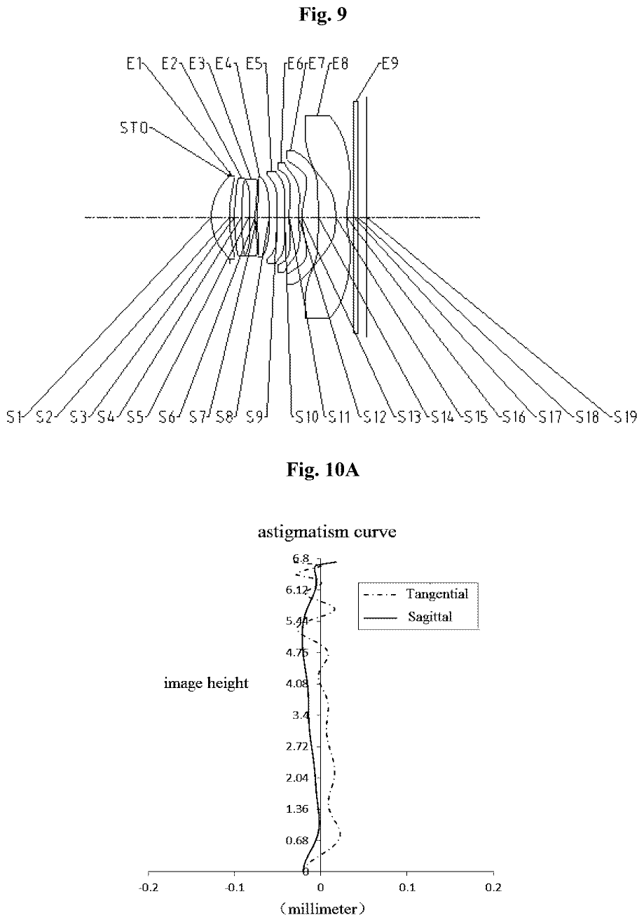

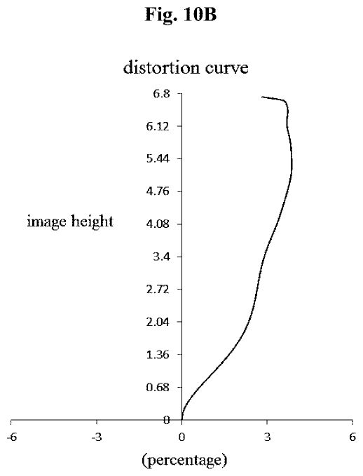

An optical imaging lens assembly according to Embodiment 5 of the disclosure is described below with reference to FIGS. 9-10B. FIG. 9 shows a structural schematic diagram of the optical imaging lens assembly according to Embodiment 5 of the disclosure.

As shown in FIG. 9, the optical imaging lens assembly sequentially includes from an object side to an image side along an optical axis: a diaphragm STO, a first lens E1, a second lens E2, a third lens E3, a fourth lens E4, a fifth lens E5, a sixth lens E6, a seventh lens E7, an eighth lens E8 and an optical filter E9. The first lens E1 is used to constitute a first lens group, and the first lens group has a positive refractive power; and the second lens E2 to the eighth lens E8 are used to constitute a second lens group, and the second lens group has a positive refractive power.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a convex surface. The eighth lens E8 has a negative refractive power, an object-side surface S15 thereof is a concave surface, and an image-side surface S16 thereof is a concave surface. The optical filter E9 has an object-side surface S17 and an image-side surface S18. The optical imaging lens assembly has an imaging surface S19, and light from an object sequentially passes through each surface from S1 to S18 and is finally imaged on the imaging surface S19.

In Embodiment 5, f is a total effective focal length of the optical imaging lens assembly, and f is 6.45 mm, TTL is a distance from the object-side surface S1 of the first lens E1 to the imaging surface S19 on the optical axis, and TTL is 8.50 mm, ImgH is a half of a diagonal length of an effective pixel region on the imaging surface S19, and ImgH is 6.73 mm.

Table 9 shows a table of basic parameters of the optical imaging lens assembly of Embodiment 5, wherein units of the curvature radius, the thickness, and the focal length are all millimeters (mm). Table 10 shows high-order coefficients that may be used for each aspheric mirror surface in Embodiment 5, wherein each aspheric surface type may be defined by formula (1) provided in Embodiment 1 above.

TABLE 9

| | | | | Material | | | |
|---|---|---|---|---|---|---|---|
| Surface | Surface | Curvature | | Refractive | Abbe | Focal | Conic |
| number | type | radius | Thickness | index | number | length | coefficient |
| OBJ | Spherical | Infinity | Infinity | | | | |
| STO | Spherical | Infinity | −0.9877 | | | | |
| S1 | Aspheric | 3.1252 | 0 9846 | 1.52 | 64.1 | 10.99 | −0.1064 |
| S2 | Aspheric | 6.2316 | 0.2715 | | | | −29.7252 |
| S3 | Aspheric | 6.4960 | 0.3857 | 1.54 | 56.1 | 50.11 | 5.8133 |
| S4 | Aspheric | 8.3424 | 0 4166 | | | | 2.9894 |
| S5 | Aspheric | 11.0627 | 0.3500 | 1.66 | 20.4 | −58.38 | −94.7658 |
| S6 | Aspheric | 8.5024 | 0.1239 | | | | −63.1294 |
| S7 | Aspheric | 55.1841 | 0.6384 | 1.54. | 56.1 | 27.43 | 98.5302 |
| S8 | Aspheric | −20.4493 | 0.4304 | | | | −37.0107 |
| S9 | Aspheric | 23.2444 | 0.4066 | 1.66 | 20.4 | −25.45 | 69.0894 |
| S10 | Aspheric | 9.7316 | 0.2547 | | | | −97.8618 |
| S11 | Aspheric | 5.7527 | 0.5118 | 1.54. | 56.1 | −24.99 | −96.7472 |
| S12 | Aspheric | 3.9184 | 0.1800 | | | | −27.1613 |
| S13 | Aspheric | 2.9203 | 0.9000 | 1.54. | 56.1 | 4.56 | −6.0436 |
| S14 | Aspheric | −14.7496 | 0.9498 | | | | −4.4404 |
| S15 | Aspheric | −9.3686 | 0.6000 | 1.54. | 56.1 | −4.54 | 1.7213 |
| S16 | Aspheric | 3.4429 | 0.4056 | | | | −7.5774 |
| S17 | Spherical | Infinity | 0.2100 | 1.52 | 64.2 | | |
| S18 | Spherical | Infinity | 0.4821 | | | | |
| S19 | Spherical | Infinity | | | | | |

TABLE 10

| Surface | | | | | |
|---|---|---|---|---|---|
| number | A4 | A6 | A8 | A10 | A12 |
| S1 | 2.1476E−04 | 4.1866E−04 | −5.5459E−04 | 5.4444E−04 | −2.9240E−04 |
| S2 | 9.3730E−03 | −3.9988E−03 | −2.2801E−04 | 1.6568E−03 | −1.2272E−03 |
| S3 | −1.7230E−02 | 1.2730E−03 | −3.7396E−03 | 4.1196E−03 | −2.3942E−03 |
| S4 | −1.1176E−02 | −3.1025E−03 | 4.1474E−03 | −4.6619E−03 | 3.1325E−03 |
| S5 | −3.8608E−03 | −6.3008E−03 | −3.9491E−04 | 1.3647E−03 | −7.6291E−04 |
| S6 | 7.2747E−03 | −2.9833E−03 | −3.5429E−03 | 3.7314E−03 | −1.9437E−03 |
| S7 | −2.0568E−03 | 8.2112E−03 | −7.5761E−03 | 5.2346E−03 | −2.5046E−03 |
| S8 | −1.8045E−02 | 1.0557E−02 | −1.0507E−02 | 7.5232E−03 | −3.5975E−03 |
| S9 | −4.0536E−02 | 2.6956E−02 | −2.3380E−02 | 1.4692E−02 | −6.2129E−03 |
| S10 | −4.5240E−02 | 3.5305E−02 | −2.5971E−02 | 1.2848E−02 | −4.1207E−03 |
| S11 | −2.0777E−02 | 1.4317E−02 | −6.7244E−03 | 9.6875E−04 | 3.1177E−04 |
| S12 | −6.5627E−02 | 3.6778E−02 | −1.5468E−02 | 3.8147E−03 | −5.3536E−04 |
| S13 | −3.2988E−02 | 1.7367E−02 | −6.6670E−03 | 1.5518E−03 | −2.3813E−04 |
| S14 | 2.1153E−02 | −1.0462E−02 | 3.3658E−03 | −7.7855E−04 | 1.1961E−04 |
| S15 | −4.3588E−02 | 3.9602E−03 | 2.1884E−04 | −3.6427E−05 | −1.0506E−06 |
| S16 | −2.5251E−02 | −1.4207E−03 | −5.1778E−04 | −1.3877E−05 | −2.6921E−06 |

| Surface | | | | |
|---|---|---|---|---|
| number | A14 | A16 | A18 | A20 |
| S1 | 9.3479E−05 | −1.7778E−05 | 1.8729E−06 | −8.6574E−08 |
| S2 | 4.7230E−04 | −1.0329E−04 | 1.2101E−05 | −5.8998E−07 |
| S3 | 8.5564E−04 | −1.8459E−04 | 2.1896E−05 | −1.0852E−06 |
| S4 | −1.5141E−03 | 3.9316E−01 | −5.5868E−05 | 3.3774E−06 |
| S5 | 2.8293E−04 | −7.2627E−05 | 1.0716E−05 | −6.3797E−07 |
| S6 | 6.4963E−04 | −1.4254E−04 | 1.8246E−05 | −9.9171E−07 |
| S7 | 7.8154E−04 | −1.5349E−04 | 1.6955E−05 | −7.8809E−07 |
| S8 | 1.0951E−03 | −2.0212E−04 | 2.0462E−05 | −8.7127E−07 |
| S9 | 1.6972E−03 | −2.8946E−04 | 2.8002E−05 | −1.1647E−06 |
| S10 | 8.4410E−04 | −1.0738E−04 | 7.7408E−06 | −2.4033E−07 |
| S11 | −1.6094E−04 | 2.9221E−05 | −2.5253E−06 | 8.6559E−08 |
| S12 | 3.4569E−05 | 5.0630E−07 | −1.9406E−07 | 7.4776E−09 |
| S13 | 2.2700E−05 | −1.2698E−06 | 3.9451E−08 | −5.6339E−10 |
| S14 | −1.2383E−05 | 8.4585E−07 | −3.4169E−08 | 6.0664E−10 |
| S15 | 3.2716E−07 | −1.9187E−08 | 4.8924E−10 | −4.7912E−12 |
| S16 | 1.1436E−07 | −3.1286E−09 | 4.8957E−11 | −3.3029E−13 |

FIG. 10A shows an astigmatism curve of the optical imaging lens assembly of Embodiment 5, which represents a curvature of tangential image surface and a curvature of sagittal image surface. FIG. 10B shows a distortion curve of the optical imaging lens assembly of Embodiment 5, which represents distortion magnitude values corresponding to different image heights. According to FIGS. 10A-10B, it can be seen that the optical imaging lens assembly provided in Embodiment 5 is capable of achieving good imaging quality.

To summarize, Embodiments 1-5 separately satisfy relationships shown in Table 11.

TABLE 11

| Conditional expression\ | | | | | |
|---|---|---|---|---|---|
| embodiment | 1 | 2 | 3 | 4 | 5 |
| ImgH × ImgH/TTL(mm) | 5.34 | 5.22 | 5.28 | 5.29 | 5.33 |
| FG2/FG1 | 3.81 | 2.95 | 3.44 | 3.49 | 3.44 |
| TTL/ImgH | 1.25 | 1.28 | 1.27 | 1.27 | 1.26 |
| f × tan(FOV/2)(mm) | 6.45 | 6.43 | 6.45 | 6.46 | 6.49 |
| f1/(R1 + R2) | 1.15 | 1.21 | 1.17 | 1.17 | 1.17 |
| f3/(f5 + f6) | 1.30 | 0.17 | 1.16 | 1.14 | 1.16 |
| (R5 + R6)/(R3 + R4) | 1.35 | 1.23 | 1.32 | 1.32 | 1.32 |
| (f7 − f8)/(R13 + R16) | 1.43 | 1.65 | 1.43 | 1.42 | 1.43 |
| (CT7 + CT8)/T78 | 1.54 | 1.48 | 1.58 | 1.56 | 1.58 |
| f34/f567 | 6.78 | 4.43 | 7.32 | 7.45 | 7.29 |
| (SAG61 + SAG62)/ | 1.46 | 0.89 | 1.39 | 1.37 | 1.39 |
| (SAG51 + SAG52) | | | | | |
| CT4/(T45 + ET4) | 1.14 | 1.33 | 1.11 | 1.12 | 1.11 |
| ET8/(ET5 + ET6 + ET7) | 1.10 | 1.35 | 1.09 | 1.02 | 1.09 |

The disclosure further provides an imaging device, and an electronic photosensitive element thereof may be a charge coupled device (CCD) or a complementary metal-oxide-semiconductor (CMOS) element. The imaging device may be a standalone imaging device, for example, a digital camera, or may be an imaging module integrated on a mobile electronic apparatus, for example, a cell phone. The imaging device is equipped with the optical imaging lens assembly described above.

The above description is merely illustrative of specific embodiment of the disclosure and of principles of the technology employed. It should be understood by those skilled in the art that the scope of the protection referred to in the disclosure is not limited to the technical solutions in which the above-described technical features are specifically combined, but also encompasses other technical solutions in which the above-described technical features or equivalent features thereof are arbitrarily combined without departing from the disclosure concept. For example, technical solutions formed by interchanging the features described above with (but not limited to) technical features disclosed in the disclosure that have similar functions.

What is claimed is:

1. An optical imaging lens assembly, sequentially comprising from an object side to an image side along an optical axis:
a first lens group having a positive refractive power and comprising a first lens; and
a second lens group having a positive refractive power and sequentially comprising from the first lens to the image side along the optical axis: a second lens, a third lens, a fourth lens, a fifth lens, a sixth lens, a seventh lens and an eighth lens, wherein the second lens has a positive refractive power;
an object-side surface of the sixth lens is a convex surface, and an image-side surface of the sixth lens is a concave surface;
the seventh lens has a positive refractive power;
the eighth lens has a negative refractive power;
ImgH is a half of a diagonal length of an effective pixel region of a photosensitive element on an imaging surface of the optical imaging lens assembly, TTL is a distance from an object-side surface of the first lens to the imaging surface on the optical axis, and ImgH and TTL satisfy: 5 mm<ImgH×ImgH/TTL<10 mm; and
at least one mirror surface from the object-side surface of the first lens to an image-side surface of the eighth lens is an aspheric surface.

2. The optical imaging lens assembly according to claim 1, wherein an effective focal length FG2 of the second lens group and an effective focal length FG1 of the first lens group satisfy: 2.7<FG2/FG1<4.2.

3. The optical imaging lens assembly according to claim 1, wherein TTL/ImgH<1.3.

4. The optical imaging lens assembly according to claim 1, wherein FOV is a maximum field of view of the optical imaging lens assembly, and FOV and a total effective focal length f of the optical imaging lens assembly satisfy: 6.0 mm<f×tan(FOV/2)<7.0 mm.

5. The optical imaging lens assembly according to claim 1, wherein an effective focal length f1 of the first lens, a curvature radius R1 of an object-side surface of the first lens and a curvature radius R2 of an image-side surface of the first lens satisfy: 1.0<f1/(R1+R2)<1.5.

6. The optical imaging lens assembly according to claim 1, wherein an effective focal length f3 of the third lens, an effective focal length f5 of the fifth lens and an effective focal length f6 of the sixth lens satisfy: 0<f3/(f5+f6)<1.5.

7. The optical imaging lens assembly according to claim 1, wherein a curvature radius R5 of an object-side surface of the third lens, a curvature radius R6 of an image-side surface of the third lens, a curvature radius R3 of an object-side surface of the second lens and a curvature radius R4 of an image-side surface of the second lens satisfy:1.0<(R5+R6)/(R3+R4)<1.5.

8. The optical imaging lens assembly according to claim 1, wherein an effective focal length f7 of the seventh lens, an effective focal length f8 of the eighth lens, a curvature radius R13 of an object-side surface of the seventh lens and a curvature radius R16 of an image-side surface of the eighth lens satisfy: 1.2<(f7−f8)/(R13+R16)<1.8.

9. The optical imaging lens assembly according to claim 1, wherein a center thickness CT7 of the seventh lens on the optical axis, a center thickness CT8 of the eighth lens on the optical axis, and a spacing distance T78 between the seventh lens and the eighth lens on the optical axis satisfy: 1.2<(CT7+CT8)/T78<1.8.

10. The optical imaging lens assembly according to claim 1, wherein f34 is a combined focal length of the third lens and the fourth lens, f567 is a combined focal length of the fifth lens, the sixth lens and the seventh lens, and f34 and f567 satisfy: 4.1<f34/f567<7.6.

11. The optical imaging lens assembly according to claim 1, wherein SAG61 is a distance from an intersection point of the object-side surface of the sixth lens and the optical axis to an effective radius vertex of the object-side surface of the sixth lens on the optical axis, SAG62 is a distance from an intersection point of the image-side surface of the sixth lens and the optical axis to an effective radius vertex of the image-side surface of the sixth lens on the optical axis, SAG51 is a distance from an intersection point of an object-side surface of the fifth lens and the optical axis to an effective radius vertex of the object-side surface of the fifth lens on the optical axis, SAG52 is a distance from an intersection point of an image-side surface of the fifth lens and the optical axis to an effective radius vertex of the image-side surface of the fifth lens on the optical axis, and SAG61, SAG62, SAG51 and SAG52 satisfy: 0.7<(SAG61+SAG62)/(SAG51+SAG52)<1.6.

12. The optical imaging lens assembly according to claim 1, wherein a center thickness CT4 of the fourth lens on the optical axis, a spacing distance T45 between the fourth lens and the fifth lens on the optical axis and an edge thickness ET4 of the fourth lens satisfy: 1.0<CT4/(T45+ET4)<1.6.

13. The optical imaging lens assembly according to claim 1, wherein an edge thickness ET8 of the eighth lens, an edge thickness ET5 of the fifth lens, an edge thickness ET6 of the sixth lens and an edge thickness ET7 of the seventh lens satisfy: 0.8<ET8/(ET5+ET6+ET7)<1.5.

14. The optical imaging lens assembly according to claim 1, wherein the first lens is made of g lass.

15. The optical imaging lens assembly according to claim 1, wherein an Abbe number of the first lens satisfies: 58<V1<70.

16. The optical imaging lens assembly according to claim 1, wherein the object-side surface of the first lens and an image-side surface of the first lens is aspheric surfaces.

17. An optical imaging lens assembly, sequentially comprising from an object side to an image side along an optical axis:
a first lens group having a positive refractive power and comprising a first lens; and
a second lens group having a positive refractive power and sequentially comprising from the first lens to the image side along the optical axis: a second lens, a third lens, a fourth lens, a fifth lens, a sixth lens, a seventh lens and an eighth lens, wherein
the second lens has a positive refractive power;
an object-side surface of the sixth lens is a convex surface, and an image-side surface of the sixth lens is a concave surface;
the seventh lens has a positive refractive power;
the eighth lens has a negative refractive power;
ImgH is a half of a diagonal length of an effective pixel region of a photosensitive element on an imaging surface of the optical imaging lens assembly, TTL is a distance from an object-side surface of the first lens to the imaging surface on the optical axis, and ImgH and TTL satisfy: TTL/ImgH<1.3; and
at least one mirror surface from the object-side surface of the first lens to an image-side surface of the eighth lens is an aspheric surface.

18. The optical imaging lens assembly according to claim 17, wherein an effective focal length FG2 of the second lens group and an effective focal length FG1 of the first lens group satisfy: 2.7<FG2/FG1<4.2.

19. The optical imaging lens assembly according to claim 17, wherein FOV is a maximum field of view of the optical imaging lens assembly, and FOV and a total effective focal length f of the optical imaging lens assembly satisfy: 6.0 mm<f×tan(FOV/2)<7.0 mm.

20. The optical imaging lens assembly according to claim 17, wherein an effective focal length f1 of the first lens, a curvature radius R1 of an object-side surface of the first lens and a curvature radius R2 of an image-side surface of the first lens satisfy: 1.0<f1/(R1+R2)<1.5.
